(19) United States
(12) Patent Application Publication
(10) Pub. No.: US 2025/0092301 A1
(43) Pub. Date: Mar. 20, 2025

(54) SWELLABLE ELASTOMERS FOR CONTROLLED SEALING OF THE ANNULAR SPACE OF A WELL AND METHODS THEREOF

(71) Applicant: Innervision Borehole Technologies Inc., Calgary (CA)

(72) Inventors: Timothy John DAVIES, Calgary (CA); Mohamad ELREFAI, Abu Dhabi (AE)

(73) Assignee: Innervision Borehole Technologies Inc., Calgary, AB (CA)

(21) Appl. No.: 18/889,044

(22) Filed: Sep. 18, 2024

Related U.S. Application Data
(60) Provisional application No. 63/583,560, filed on Sep. 18, 2023.

(51) Int. Cl. C09K 8/44; E21B 33/138

(52) U.S. Cl. CPC C09K 8/44; E21B 33/138

(57) ABSTRACT

A high temperature swellable formulation for the controlled sealing of an annular space in a well includes at least one of an elastomer, a density modifier incorporated with the elastomer, an excipient. The elastomer is selected from the group consisting of oil-swelling elastomers, water-swelling elastomers, and hybrid-swelling elastomers. A method for the controlled sealing of an annular space in a well includes using the high temperature swellable formulation.

### CROSS-REFERENCE TO RELATED APPLICATION

This application claims priority to U.S. Provisional Patent Application Ser. No. 63/583,560, filed Sep. 18, 2023 and entitled SWELLABLE ELASTOMERS FOR CONTROLLED SEALING OF THE ANNULAR SPACE OF A WELL AND METHODS THEREOF, the disclosure of which is incorporated herein by reference.

### FIELD OF THE INVENTION

The present disclosure broadly relates to well cementing/sealing. More particularly the present disclosure relates to formulations and methods for sealing leaks in the annulus of a well by using swellable elastomers.

### BACKGROUND

Globally, the petroleum industry's common challenges are maximizing oil production while reducing developmental and operational costs, maintaining the profitability of old wells, and exploiting economically inaccessible new reservoirs. With the vast development of the offshore oil and petroleum industry, most of the offshore oil well production faces high temperature, high pressure, and highly corrosive oil-containing downhole environment, and the phenomenon of abnormal pressure carried in the annulus column is rapidly increasing. Oil and gas wells are often cased from the surface location of the wells down to and sometimes through a subterranean formation. A steel pipe is generally lowered into a wellbore to a desired depth and conventionally at least a portion/zone of the space between the steel pipe and the wellbore, i.e., the annulus, is then typically filled with cement to secure the steel pipe within the wellbore. Once the cement sets in the annulus, it holds the steel pipe in place and prevents the flow of fluids from, or between various zones of a subterranean formation through which the well passes. Further, the zonal isolation and optimization of the well size are essential for economic production in the case of both conventional and deep-water wells. Some issues such as failure of equipment or application strategy, lack of reliability, complexity of deployment, operational issues, and higher energy requirement for initialization, can become hurdles thereby escalating the costs substantially.

For a clean and economical extraction, isolating two or more portions of the well is desirable, especially during perforating, fracturing, and cementing operations. The downhole tubing in a gas well is affected by many factors such as high-pressure erosion, gas lift operation, sand production at the bottom of the well and engineering construction, etc., which can easily lead to leakage of the threaded joints of the tubing and the pipe body, and the leaked natural gas will invade annulus, making the annulus under pressure, thereby causing a major safety hazard in oil and gas production.

Additionally, well environments have become more complex due to deeper, hotter, and higher pressures that require more complicated completion designs and tools. However, the requirement for effective, long-term isolation points has remained the same. With the added challenges that must be addressed in today's wells, traditional methods of achieving the required isolation have become more problematic, and often have further increased the complexity of the wells.

Due to technological advancement, the oil industry has witnessed the advent of new technologies such as horizontal drilling, multi-stage fracturing, and innovative methods of reservoir management. Moreover, the use of the traditional methods of cementing “in place” reduces productivity and the non-cemented completions require some sort of an open-hole packer. Conventionally, mechanical packers with hydraulic actuation were used for providing an annular seal between the production casing and the rock formation. In unconventional reservoirs, or cases such as slotted liners, pressure buildup for packer setup is not only difficult but at times impossible.

The relatively new swelling elastomer technology offers innovative and economically viable solutions. It has been successfully tried out in a variety of applications due to its simplicity of design, relatively inexpensive production, and ease of installation and initialization. These new applications are aimed at improved oil recovery and enhanced oil recovery through slimming of well design, reliable zonal isolation, and successful water shutoff. Initially developed as a mitigation strategy for repairing damaged wells, swelling elastomers are now targeting major cost and time savings through reduced borehole diameter, casing clearance, and cementless completions. EP1672166A1 discloses elastomers having a swellable core surrounded by a coating wherein the rubber of the core can have other materials dissolved therein or maybe a mixture containing fibers. EP1672166A1 also discloses that rubber in a mechanical mixture with other polymers expands upon contact with oils having a higher resistance to the fluid and lower rates of diffusion for the fluid than the core. Thus, the coating retards the rates of swelling and therefore can provide a delay in the swelling of the core, preventing the core from premature swelling. However, this same property of the coating also leads to longer times for the cores to expand and for the packers to set and seal.

U.S. Ser. No. 11/769,207 discloses temporary containments for swellable packer elements and methods for creating temporary containments by using sleeves made of materials that are soluble in specific activation fluids. The dissolvable protective sleeves can prevent premature and undesired swelling of the packers. When it is desired to expand the packer, the temporary containments are dissolved (e.g., by introducing an activation fluid) to allow the swellable polymers in the cores to contact the fluids to allow the packers to expand.

US20060185849 discloses a device that consists of a swellable elastomer core with a protective layer for fluid control. The protective layers may be removed by mechanisms, such as temperature, chemicals, radiation, or mechanical techniques. US20050199401 discloses devices with protective coatings that may be disintegrated by selected chemicals. These selected chemicals can be introduced into the wellbore in the form of a pill or through a control line.

Many inventions in the state of art disclose the use of swelling agents for containing the leaks caused in the oil and petroleum industry. However, these prior arts disclose methods to delay and control the timing and rates of swellable packer expansion, there is still a need for better methods and devices, proper choice of material for controlling the deployment and setting of swellable packers or similar devices downhole leading to sealing for a long period without failure.

Thus, combined with the fact that oilfield trends exhibit an increased need for simplified operations that enhance reliability rather than make it more complex. Hence, there is therefore felt a need for economical, reliable, simple yet fast swellable elastomers for controlled sealing of the annular space of a well that swells but does not substantially degrade or disintegrate upon long-term exposure to water and water-based fluids, such as brines, and optionally in hydrocarbon fluids.

### SUMMARY OF THE INVENTION

Accordingly, the present invention in one aspect provides a high temperature swellable formulation for the controlled sealing of an annular space in a well. The formulation comprises at least one elastomer selected from the group consisting of oil-swelling elastomers, water-swelling elastomers, and hybrid-swelling elastomers, at least one density modifier incorporated with the elastomer and at least one excipient. The density modifier comprising a metallic substance with a predetermined particle size distribution and at least one excipient selected from the group consisting of binders and stabilizers. The elastomer is configured to undergo a volumetric increase upon contact with a fluid present in the annulus at the site of a leak, the volumetric increase being modulated by specific temperature and pressure conditions. Further, the density modifier is configured to adjust the sink rate and spatial distribution of the formulation within the annular space, and wherein the density modifier enhances the rate of formulation descent through various fluid viscosities encountered in the annulus. Also, the binder is chemically compatible with the elastomer and the density modifier and maintains the integrity of the formulation while not adversely affecting the swelling kinetics of the elastomer.

The present invention in another aspect provides a method for the controlled sealing of an annular space in a well. The method comprises the steps of initially detecting a leak site within the annular space utilizing a leak detection system followed by deploying a predetermined quantity of the formulation to the detected leak site via a controlled delivery mechanism, wherein the deployment is orchestrated to achieve precise placement of the formulation within the annular space. Lastly the formulation is induced to swell upon contact with the fluid at the leak site, wherein the swelling is initiated by specific environmental conditions of temperature and pressure, resulting in crosslinking and bonding of the formulation with the casing and tubing surfaces to form a durable seal.

The sealant product will be delivered into the well using existing technologies for containment, mixing and wellhead entry.

The present invention relates to the development of a novel swellable, shape and size customizable and density adjustable formulation.

### BRIEF DESCRIPTION OF THE DRAWINGS

The accompanying drawings, which are incorporated in and constitute a part of this disclosure, illustrate exemplary embodiments and, together with the description, serve to explain the disclosed principles. Having thus described example embodiments of the disclosure in general terms, reference will now be made to the accompanying drawings, which are not necessarily drawn to scale, and wherein:

FIG. 1 illustrates a typical well diagram with A & B annuli comprising a leak through the casing packer, in accordance with an example of the present disclosure;

FIG. 2 illustrates the placement of the formulation by gravity inside the A-Annulus, in accordance with an example of the present disclosure; and

FIG. 3 illustrates the formation of the seal by the formulation inside A-Annulus, in accordance with an example of the present disclosure.

### DETAILED DESCRIPTION

The detailed description set forth below, in connection with the appended drawing, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. As described herein, the use of the term “and/or” is intended to represent an “inclusive OR”, and the use of the term “or” is intended to represent an “exclusive OR”.

The disclosure will now be described with reference to the accompanying embodiments which do not limit the scope and ambit of the disclosure. The description provided is purely by way of example and illustration.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

In some embodiments, the numbers expressing quantities of ingredients, properties such as concentration, and so forth, used to describe and claim certain embodiments of the invention are to be understood as being modified in some instances by the term “about.” Accordingly, in some embodiments, the numerical parameters set forth in the written description are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable.

The recitation of ranges of values herein is merely intended to serve as a shorthand method of referring individually to each separate value falling within the range. Unless otherwise indicated herein, each individual value is incorporated into the specification as if it were individually recited herein.

All methods described herein can be performed in suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

### Definitions

In the context of the present application and disclosure, the following definitions apply:

Elastomers: Polymers that exhibit volume increase when immersed in water or oil are known as swelling elastomers. They can be at least one from the following:
Oil-swelling elastomers that swell when exposed to hydrocarbons;
Water-swelling elastomers that swell when exposed to water; and
Hybrid-swelling elastomers combine the capabilities of both oil- and water-swelling polymers into a single compound.

Annulus: The annulus of an oil well or water well is any void between any piping, tubing, or casing and the piping, tubing, or casing immediately surrounding it. The presence of an annulus gives the ability to circulate fluid in the well, provided that excess drill cuttings have not accumulated in the annulus, preventing fluid movement and possibly sticking the pipe in the borehole. In well engineering, the annular space between the production tubing and production casing is called A-annulus and next Annulus will be B-Annulus, and so on.

The sealing formulations focus on the unique properties and specific applications to leaks in well annuli. The formulation is to be introduced into the annulus and the “pellets” drop through any existing fluids in the annulus via gravity. Therefore, the “pellets” are doped (i.e., mixed with a metallic substance to increase their density and thereby their weight assisting in optimal speed of delivery and placement in the annulus).

As mentioned hereinabove, the well annulus should be devoid of any hydrocarbon fluid or gas under standard operating practices. However, due to any of the aforementioned reasons, failure may occur in the existing well barrier leading to leaks through the damaged barrier into the well annulus. Generally, the leak is observed from the downhole packer where the seal elements degrade with time due to tubing movement and high temperature. Once the leak begins, the pressure starts to build up in the annulus and the same needs to be dealt with at the earliest.

The present disclosure in one aspect discloses a high temperature swellable formulation for the controlled sealing of the annular space of the well. Upon detection of any leak in the annular space of the well, the formulation of the present disclosure is released such that it reaches the site of the leak at a faster rate and swells upon contact with the fluid thereby forming a seal. The swelling is initiated by specific temperature and pressure according to the parameters of the target well. Based on the depth and type of the leak, the formulation of the present disclosure is tuned such that it swells at a particular temperature and pressure range. Typically, with an increase in the depth, the temperature and pressure also increase, accordingly the formulation is tuned to avoid any early or delayed swelling. Thus, the seal is achieved at the site of the leak.

The formulation comprises a predetermined amount of at least one elastomer, a predetermined amount of at least one suitable density modifier and at least one suitable excipient. At least one elastomer is initially ground to obtain a variable particle size and then mixed with a predetermined amount of density modifier to obtain the formulation of the present disclosure. In an exemplary embodiment of the present disclosure, at least one suitable excipient is a binder or a stabilizer or combinations thereof. Typically, the binder is chemically compatible with the elastomer and the density modifier and maintains the integrity of the formulation while not adversely affecting the swelling kinetics of the elastomer. The formulation is customized according to the characteristics of the target well.

As previously described, the formulation comprises at least one elastomer, at least one density modifier and at least one excipient. This combination allows the elastomer to expand from a smaller initial volume to a larger final volume when exposed to any fluid. Notably, some elastomers on their own do not swell upon contact with water and may be considered inert in this regard. However, certain elastomer compounds can swell or expand when interacting with liquid hydrocarbons or oil-based liquids.

In some of the discussed embodiments, a formulation is employed, where the elastomer incorporates metal particles as a density modifier. The formulation is customized to swell when it comes into contact with either or any aqueous fluids, oil-based fluids or by a mixture of these fluids depending on the characteristics of the fluids present in the target well's annulus.

When the formulation transitions to its expanded configuration, its volume increases, leading it to make contact with adjacent surfaces, such as the inner diameter of a tubular and other adjacent surfaces. This increased contact pressure between the elastomer and the adjacent surface enhances the sealing capability of the packer. The seal formed effectively inhibits fluid flow across the elastomer, providing zonal isolation or restricting fluid flow within the annulus of a fluidic channel. This ensures that fluid flow is either prevented or significantly restricted, achieving the desired isolation or control in the subterranean environment.

In one embodiment of the present disclosure, at least one elastomer is selected from the group consisting of, but not limited to, oil-swelling elastomers, water-swelling elastomers, and hybrid-swelling elastomers. In an exemplary embodiment of the present disclosure, the at least one elastomer is selected from the group comprising of natural polyisoprene such as cis-1,4-polyisoprene and trans-1,4-polyisoprene, 1,2-polyisoprene, 3,4-polyisoprene, synthetic polyisoprene, polybutadiene, polychloroprene, polyisobutylene, chloro butyl rubber, bromo butyl rubber, styrene-butadiene rubber, nitrile rubber, hydrogenated nitrile rubber, ethylene propylene rubber, ethylene propylene diene rubber, epichlorohydrin rubber, polyacrylic rubber, silicone rubber, fluorosilicone rubber, fluoroelastomers (also known as FKM's which may be defined by ASTM D1418) such as copolymers of hexafluoropropylene and vinylidene fluoride, terpolymers of tetrafluoroethylene, vinylidene fluoride, and hexafluoropropylene, and copolymers of tetrafluoroethylene, propylene, ethylene, tetrafluoroethylene, and perfluoromethylvinylether, perfluoroelastomers such as copolymers of vinylidene fluoride and hexafluoropropylene, terpolymers of vinylidene fluoride, hexafluoropropylene, and tetrafluoroethylene, terpolymers of vinylidene fluoride, tetrafluoroethylene, and perfluoromethylvinylether, terpolymers of propylene, tetrafluoroethylene, and vinylidene fluoride, and polymers of vinylidene fluoride, hexafluoropropylene, tetrafluoroethylene, perfluoromethylvinylether, and ethylene, polyether block amide, chlorosulfonated polyethylene, ethylene-vinyl acetate, thermoplastic elastomers, polysulfide rubber, and combinations thereof.

The choice of the elastomer in the formulation depends upon the type of leak, i.e., if addressing an oil, water, or a mixture of oil and water leak, the corresponding elastomer/s are used.

In another embodiment of the present disclosure, at least one elastomer is selected from the group consisting of, but not limited to, swellable rubber elements and other polymers that swell at different rates. These other polymers that swell at different rates are calculated on a per application basis. Typically, at least one elastomer has a predetermined size, shape, weight, and variable density.

In one exemplary embodiment of the present disclosure, at least one elastomer has variable density such that the elastomer can settle at different rates in the annulus, thereby providing a possibility of structuring a seal with different properties and different sink rates. The variable weight, size and geometric configuration of the formulation allows for the layering of multiple leak sealing treatments during the same well annulus remediation.

Generally, the density of at least one elastomer is greater than 1 gm/cm³.

In another embodiment of the present disclosure, the formulation has variable shapes and sizes for ensuring a random distribution around the annulus leak and allowing for the ability to seal areas with variable geometry. In an exemplary embodiment of the present disclosure, the formulation is formed in the shape of a ball using molds of variable sizes. These molds also impart specific patterns such as a dimpled texture, ridges, and aerodynamic contours like that of a golf ball to reduce drag, thereby reaching the site of the leak at a faster rate. Such modifications of the surface geometry of the formulation enables to control the spin rate, drop rate and the sink rate of the formulation. The elastomer is ground to achieve a particle size distribution tailored to the specific thermal and pressure conditions of the well annulus, and wherein the ground elastomer is mixed with the density modifier to achieve a specific formulation density and swelling profile suitable for the well environment. Further, the elastomer used can be manufactured in a variety of forms, including powders, shavings, spheres and flakes. The shapes can be spheres, ellipsoids, irregular shaped and textured bodies or any other geometry or configuration appropriate to the leak sealing requirements. The geometric configuration is optimized to ensure homogeneous dispersion and effective sealing of variable annular geometries. It can also be produced in a broad spectrum of particle sizes, ranging from approximately 10 nanometers to 5 centimeters. By adjusting the particle size and density or the distribution of the elastomer and metallic particles within the formulation of the “pellets”, the rate at which the formulation reaches its expanded state can be controlled. Generally, smaller particles of swellable elastomers tend to swell more rapidly compared to larger ones. Therefore, selecting the correct form and particle size of the elastomers and metallic particles is crucial for tailoring the formulation of the resulting “pellets” to meet the specific needs of its intended application. Staged application of the variously sized pellets can be used to create layering of the leak sealing product thereby expanding its range applications. A person ordinarily skilled in the art in view of this application should be able to select an appropriate shape and particulate size range for the formulation for a particular type of leak and position of the leak.

In still another embodiment of the present disclosure, the swelling of at least one elastomer is determined by the shape and environmental conditions in the packer's location and also modulated by specific temperature and pressure conditions.

In yet another embodiment of the present disclosure, the swelling ratio of at least one elastomer is controlled and can be customized as per the requirement.

In an embodiment of the present disclosure, for even settling and transport of the formulation, a pre-determined amount of turbulence is applied.

In another embodiment of the present disclosure, at least one suitable density modifier is a metal having a pre-determined particle size. The density modifier comprises a metallic substance with a predetermined particle size distribution, wherein the density modifier is configured to adjust the sink rate and spatial distribution of the formulation within the annular space. Further, the density modifier enhances the rate of formulation descent through various fluid viscosities encountered in the well. The density modifier is selected from the group consisting of tungsten, bismuth, and lead. The metallic substance is configured to control the sedimentation velocity and penetration depth of the formulation based on the particle size and distribution parameters.

Typically, the metal is tungsten. The density of at least one metal particle is greater than at least one elastomer particle. Typically, at least one suitable metal particle aids the formulation to reach the location of the leak in less time through a variety of viscous materials at a controlled manner. The drop rate is modified/controlled by the change in the amount of density modifier incorporated into the elastomer (i.e., volume or number of metallic particles not necessarily due to the size of particle).

The ratio of the elastomer and density modifier particle is modulated to control the sink rate and selectively layer in compounds of different properties to achieve desired swelling responses to conform to different geometries found within the leak. Typically, the ratio of the elastomer to the density modifier is dynamically adjustable to achieve a predetermined sink rate and swelling response, thereby enabling the formulation to conform to diverse leak geometries and fluid compositions within the annular space.

In yet another embodiment of the present disclosure, the formulation of the present disclosure can be placed above the tubing packer section. In still another preferred embodiment of the present disclosure, the formulation of the present disclosure can be dropped to the site of the leak upon detection of the same.

In another aspect of the present disclosure, disclosed is a method for controlled sealing of the annular space of a well. The method involves the following steps: (a) detecting the site of leak within the annular space utilizing an industry standard leak detection system; (b) deploying a predetermined quantity of the formulation to the detected leak site via a controlled delivery mechanism. Typically, the deployment is orchestrated to achieve precise placement of the formulation within the annular space; and (c) inducing the formulation to swell upon contact with the fluid present at the leak site, wherein the swelling is initiated by specific environmental conditions of temperature and pressure, resulting in crosslinking and bonding of the formulation with the casing and tubing surfaces to form a durable seal. Upon exposure to downhole fluids, the formulation reacts which causes the elastomers in the formulation to expand. This reaction can occur via:
Water Absorption: For SAPs and swellable salts.
Hydrocarbon Interaction: For certain elastomers and swellable materials that interact with oil-based fluids.
Combination of aqueous and oil-based fluids

In an embodiment of the present disclosure, the type of elastomer is selected depending on the type and location of leak.

In another embodiment of the present disclosure, the formulation is deployed by gravity-assisted delivery. The delivery process includes calculating the volume and distribution of the formulation to ensure optimal coverage and sealing within the vertical sections of the well annulus.

In yet another embodiment of the present disclosure, the pre-determined amount of the formulation is calculated using a volume calculator so that the formulation can reach the vertical section of the annulus.

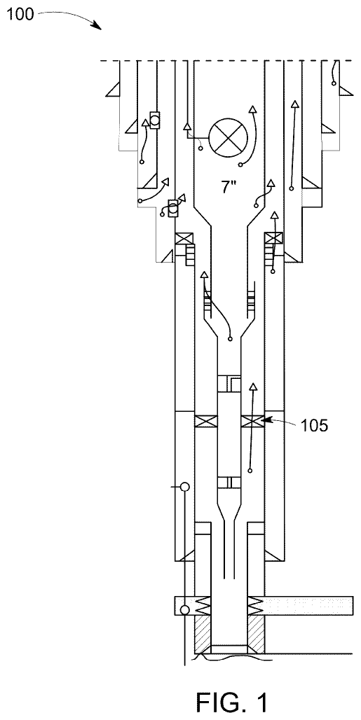

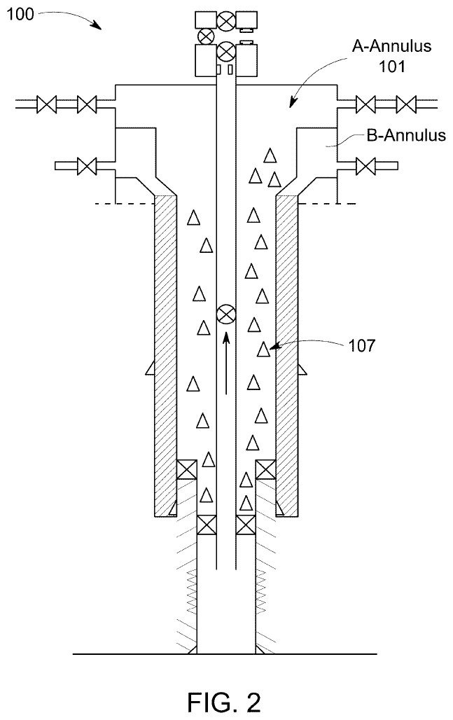

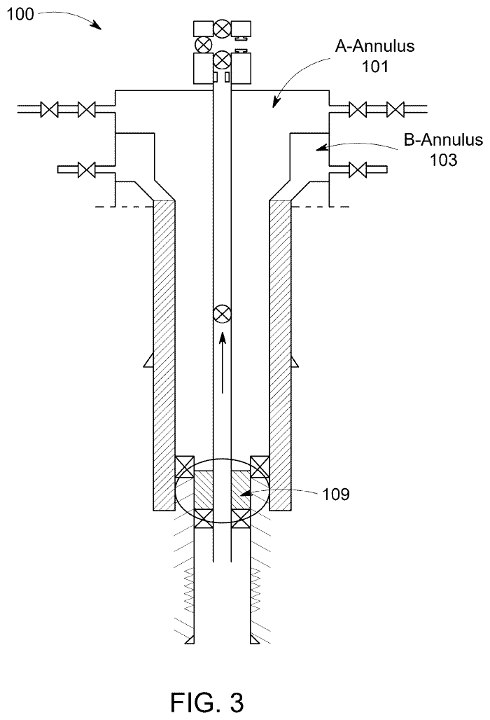

In yet another aspect of the present disclosure, with reference now to FIG. 1, there is provided an example of a typical well diagram (100) with A-annulus (101) and B-annulus (103) comprising a leak through the casing packer (105). In FIG. 1, a borehole has been drilled from the surface of the earth. An upper portion of the borehole has been lined with casing which has been sealed to the borehole by cement. Below the cased portion of the borehole is an open hole portion that extends downward and then through various earth formations. For example, the borehole may pass through a water-bearing zone, a nonproductive zone, a shale layer, and into an oil-bearing zone. A leak has formed a leak through the casing packer (105). Accordingly, the present disclosure discloses a formulation and method for the controlled sealing of the annular space of the well. In FIG. 2 illustrated is the formulation (107) of the present disclosure dropped by gravity inside the A-annulus (101) towards the leak at the casing packer (105). The leak is detected using any conventional technologies which also detects the type of the fluid, i.e. if the fluid is water, oil or a mixture of oil and water. Once the type of fluid is identified, corresponding formulation to react with that fluid and form a seal is dropped in the A-annulus (101) towards the leak at the casing packer (105). Due to the formulation comprising at least one density modifier, the formulation reaches the site of leak in less time. FIG. 3 illustrates the formation of the seal (109) by the formulation inside A-Annulus (101). The formulation starts swelling upon contact with the fluid on the site of leak such that its volume increases, leading it to make contact with adjacent surfaces. This increased contact pressure between the formulation and the adjacent surface enhances the sealing capability of the packer. The seal formed effectively inhibits fluid flow across the casing packer (105), thereby providing zonal isolation or restricting fluid flow within the annulus of a fluidic channel.

In yet another embodiment of the present disclosure, the delivery system is designed to facilitate gravity-driven or pressure-assisted deployment of the formulation, and includes sensors for monitoring the formulation's progress and ensuring accurate placement at the leak site.

In an exemplary embodiment of the present disclosure, a leak detected through the casing packer (105) and the type of fluid that seeps in is detected. Upon detection of the fluid, suitable elastomers are chosen from oil-swelling elastomers, water-swelling elastomers and hybrid-swelling elastomers along with tungsten as a density modifier. Such a formulation guided at the site of leak swells instantly upon contact with the fluid and forms a seal thereby inhibiting the fluid flow across the casing packer (105), and simultaneously providing zonal isolation or restricting fluid flow within the annulus of a fluidic channel.

The formulation of the present disclosure described herein above has several technical advantages including, but not limited to, the realization of a quick settling formulation that does not require any pumping, rotation, running/setting tools, pressure, dropping balls. The method of the present disclosure is simple for a controlled sealing of the annular space of a well which simplifies the overall operation as there is almost never a need for a dedicated operator to be present. Moreover, the formulation creates a seal devoid of any potential weak spot or leak path through the tubing because as the formulation swells, it can mold itself and seal the annulus in open or cased-hole environments.

The description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein are to be accorded the widest scope consistent with the principles and novel features disclosed herein.

This has outlined, rather broadly, the features and technical advantages of the present disclosure in order that the detailed description may be better understood. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further purposes and advantages, will be better understood from the description when considered in connection with the accompanying figures. It is to be expressly understood, however, that each of the figures is provided for the purposes of illustration and description only and is not intended as a definition of the limits of the present disclosure.

Although several embodiments have been described in detail for purposes of illustration, various modifications may be made without departing from the scope and spirit of the present disclosure. Accordingly, the disclosure is not to be limited by the examples presented herein.

What is claimed:

1. A high temperature swellable formulation for the controlled sealing of an annular space in a well, comprising:
a) at least one elastomer selected from the group consisting of oil-swelling elastomers, water-swelling elastomers, and hybrid-swelling elastomers;
wherein said elastomer is configured to undergo a volumetric increase upon contact with a fluid present at the site of a leak, said volumetric increase being modulated by specific temperature and pressure conditions determined by the specific properties of the target well annulus;
b) at least one density modifier incorporated with said elastomer; said density modifier comprising a metallic substance with a predetermined particle distribution with elastomer particle sizes ranging from 10 nanometers to 5 centimeters, wherein said density modifier is configured to adjust the sink rate and spatial distribution of the formulation within the annular space, and wherein said density modifier enhances the rate of formulation descent through various fluid viscosities encountered in the well; and
c) at least one excipient selected from the group consisting of binders and stabilizers;
wherein said binder is chemically compatible with said elastomer and said density modifier, and maintains the integrity of said formulation while not adversely affecting the swelling kinetics of the elastomer.

2. The formulation as claimed in claim 1, wherein said elastomer is ground to achieve a particle size distribution tailored to the specific thermal and pressure conditions of the well annulus, and wherein said ground elastomer is mixed with the density modifier to achieve a specific formulation density and swelling profile suitable for the well environment and leak characteristics and annular components, configuration and fluids present in the annulus.

3. The formulation as claimed in claim 1, wherein said density modifier is selected from the group consisting of tungsten, bismuth, and lead, and wherein said metallic substance are configured to control the sedimentation velocity and penetration depth of the formulation based on the particle size and distribution parameters.

4. The formulation as claimed in claim 1, wherein said elastomer exhibits a density in excess of 1 gm/cm³ and is geometrically shaped into forms selected from the group consisting of spheres, ellipsoids, irregular shapes and textured bodies, wherein the geometric configuration is optimized to ensure homogeneous dispersion and effective sealing of variable annular geometries.

5. The formulation as claimed in claim 4, wherein said elastomer is molded into specific geometrical shapes with surface features selected from the group consisting of dimples, ridges, and aerodynamic contours;
wherein said surface features are designed to minimize drag and enhance the formulation's ability to navigate through the annular space to the site of the leak.

6. The formulation as claimed in claim 1, wherein the ratio of the elastomer to the density modifier is dynamically adjustable to achieve a predetermined sink rate and swelling response, thereby enabling the formulation to conform to diverse leak geometries and fluid compositions within the annular space.

7. A method for the controlled sealing of an annular space in a well, comprising:
a) detecting a leak site within the annular space utilizing a leak detection system;
b) deploying a predetermined quantity of the formulation as claimed in claim 1 to said detected leak site via a controlled delivery mechanism, wherein said deployment is orchestrated to achieve precise placement of the formulation within said annular space;
c) inducing said formulation to swell upon contact with the fluid at said leak site, wherein the swelling is initiated by specific environmental conditions of temperature and pressure, resulting in crosslinking and bonding of the formulation with the casing and tubing surfaces to form a durable seal.

8. The method as claimed in claim 7, wherein said formulation is deployed by gravity-assisted delivery, and wherein the delivery process includes calculating the volume and distribution of the formulation to ensure optimal coverage and sealing within the vertical sections of the well annulus.
